(19) United States
(12) Patent Application Publication
(10) Pub. No.: US 2022/0230214 A1
(43) Pub. Date: Jul. 21, 2022

(54) USED CAR SELLING SYSTEM AND USED CAR SELLING METHOD

(71) Applicant: TOYOTA JIDOSHA KABUSHIKI KAISHA, Toyota-shi (JP)

(72) Inventor: Tatsuya ODAGAWA, Nagoya-shi (JP)

(21) Appl. No.: 17/515,982

(22) Filed: Nov. 1, 2021

(30) Foreign Application Priority Data
Jan. 20, 2021 (JP) 2021-007113

(51) Int. Cl. G06Q 30/06

(52) U.S. Cl. CPC G06Q 30/0601

(57) ABSTRACT

A management server retrieves information on target used cars as sales targets from dealer servers, and determines whether or not the target used cars are fittable with the travel safety system based on the information stored in a storage device. The management server executes processing to arrange the travel safety system for the target used cars fittable with the travel safety system. The management server posts the target used cars on an online sales site, and executes processing to sell the target used cars fitted with the travel safety system.

### CROSS-REFERENCE TO RELATED APPLICATION

This application claims priority to Japanese Patent Application No. 2021-007113 filed on Jan. 20, 2021, incorporated herein by reference in its entirety.

### BACKGROUND

### 1. Technical Field

The present disclosure relates to a used car selling system and a used car selling method for use in used car sales.

### 2. Description of Related Art

Japanese Unexamined Patent Application Publication No. 2004-13453 (JP 2004-13453 A) discloses a method of selling in-vehicle equipment that is applicable to a method of selling car audio systems, car navigation systems, and the like, at the time of used car sales. Specifically, the selling method supports arrangement of the equipment to be equipped on used cars in response to accesses from dealer terminals installed at used car dealers to allow the equipment to be arranged in the same way as in the sales of new cars (see JP 2004-13453 A).

### SUMMARY

Means for promoting used cars sales may include enhancing the appeal of used cars as a product. The method disclosed in JP 2004-13453 A is convenient for users since the method saves the users the labor of going to car shops to arrange purchase of car audio systems and other equipment after purchasing used cars. On the other hand, the method may not necessarily contribute to the enhancement of the appeal of used cars as a product, because the users may possibly be able to select the car audio systems and other equipment suitable for their tastes from wider options by going to car shops.

The present disclosure has been made in order to solve such an issue, and an object of the present disclosure is to provide a used car sales system and a used car sales method capable of enhancing the appeal of used cars as a product.

A used car sales system in the present disclosure is a used car selling system for use in used car sales. The used car selling system includes a storage device and a controller. The storage device is configured to store information on vehicles that are retrofittable with a travel safety system relating to travel safety performance of the vehicles. The controller is configured to acquire information on target used cars as sales targets and determine, based on the information stored in the storage device, whether or not the target used cars are vehicles fittable with the travel safety system. The controller is configured to execute first processing to arrange the travel safety system for the target used cars fittable with the travel safety system, and execute second processing to sell the target used cars fitted with the travel safety system.

A used car selling method in the present disclosure is a used car selling method for use in used car sales. The used car selling method includes: a step of acquiring first information including information on target used cars as sales targets; a step of acquiring second information including information on vehicles retrofittable with a travel safety system relating to travel safety performance of the vehicles; a step of determining based on the second information whether or not the target used cars are vehicles fittable with the travel safety system; a step of arranging the travel safety system for the target used cars that are determined to be fittable with the travel safety system; and a step of selling the target used cars fitted with the travel safety system.

In the used car selling system and the used car selling method, it is possible to sell used cars fitted with the travel safety system relating to the travel safety performance of vehicles at the time of used car sales. The demands for mounting such a travel safety system are growing in recent years. Selling the used cars fitted with the travel safety system can greatly contribute to enhancing the appeal of the used cars as a product at the time of used car sales. The travel safety system is also not a kind of systems that users go to car shops and select to suit their tastes after purchase of used cars. Hence, travel safety system contributes to enhancing the appeal of used cars as a product at the time of used car sales. Therefore, according to the used car selling system and the used car selling method, it is possible to enhance the appeal of used cars as a product.

The travel safety system may include a pedal misapplication acceleration control system configured to reduce acceleration of the vehicles caused by pedal misapplication between an accelerator pedal and a brake pedal.

The demands for the pedal misapplication acceleration control system are growing more and more in recent years. Selling the used cars fitted with the pedal misapplication acceleration control system can largely enhance the appeal of the used cars as a product at the time of used car sales.

The first processing may include processing to sort out, from the target used cars fittable with the travel safety system, target used cars to be fitted with the travel safety system in accordance with a prescribed parameter, and processing to arrange the travel safety system for the sorted-out target used cars.

According to the configuration, it is possible to collectively arrange the travel safety system and fit the travel safety system on the target used cars sorted out as the target used cars to be fitted with the travel safety system according to the prescribed parameter. This makes it possible to enhance the efficiency of an operation of selling the used cars with the travel safety system fitted thereto.

The first processing may further include processing to determine the travel safety system fittable for each of the target used cars in accordance with the parameter.

Accordingly, it is possible to collectively arrange the travel safety system and fit the travel safety system to the target used cars that are sorted out for each of the fittable travel safety systems. This makes it possible to further enhance the efficiency of the operation.

The prescribed parameter may include at least one of a model type, a model year, and a sales region of the vehicles. Accordingly, the target used cars to be fitted with the travel safety system can appropriately be sorted out according to the parameter such as the model type, the model year, the sales region of the vehicles. Therefore, it is possible to collectively arrange the travel safety system for the target used cars sorted out by the model type, model year, and sales region of the vehicles, and sell desired target used cars with the travel safety system or systems fitted thereto.

The controller may be configured to receive fitting of the travel safety system from a prospective buyer of the target used car. The first processing may include processing to arrange the travel safety system, received from the prospective buyer, for the target used car fittable with the travel safety system. The second processing may include selling the target used car fitted with the travel safety system arranged by the first processing to the prospective buyer.

According to the configuration, the travel safety system can be arranged and fitted on a used car for sale in response to a request from the prospective buyer of the target used car. This makes it possible to enhance the appeal of the used car as a produced to reflect the user's request.

According to the used car selling system and the used car selling method, it is possible to enhance the appeal of used cars as a product.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 schematically shows the overall configuration of a used car selling system according to a first embodiment;

FIG. 2 shows an example of a flow until target used cars are posted on an online sales site;

FIG. 3 shows the configuration of a management server shown in FIG. 1;

FIG. 4 shows a configuration example of data stored in a sales vehicle information DB in the management server;

FIG. 5 shows a configuration example of data stored in a rework information DB in the management server;

FIG. 6 shows a configuration example of data stored in the rework information DB in the management server;

FIG. 7 shows a configuration example of data stored in the rework information DB in the management server;

FIG. 8 is a flowchart showing an example flow of processing executed in the management server;

FIG. 9 is a flowchart for illustrating an example of travel safety system arrangement processing executed in step S50 in FIG. 8;

FIG. 10 is a flowchart showing an example flow of processing executed in the management server in a second embodiment; and

FIG. 11 is a flowchart for illustrating an example of travel safety system arrangement processing executed in step S250 in FIG. 10.

### DETAILED DESCRIPTION OF EMBODIMENTS

Embodiments of the present disclosure will be described hereinafter in detail with reference to the drawings. Note that identical or like component members are designated by identical reference numerals to omit the description thereof.

### First Embodiment

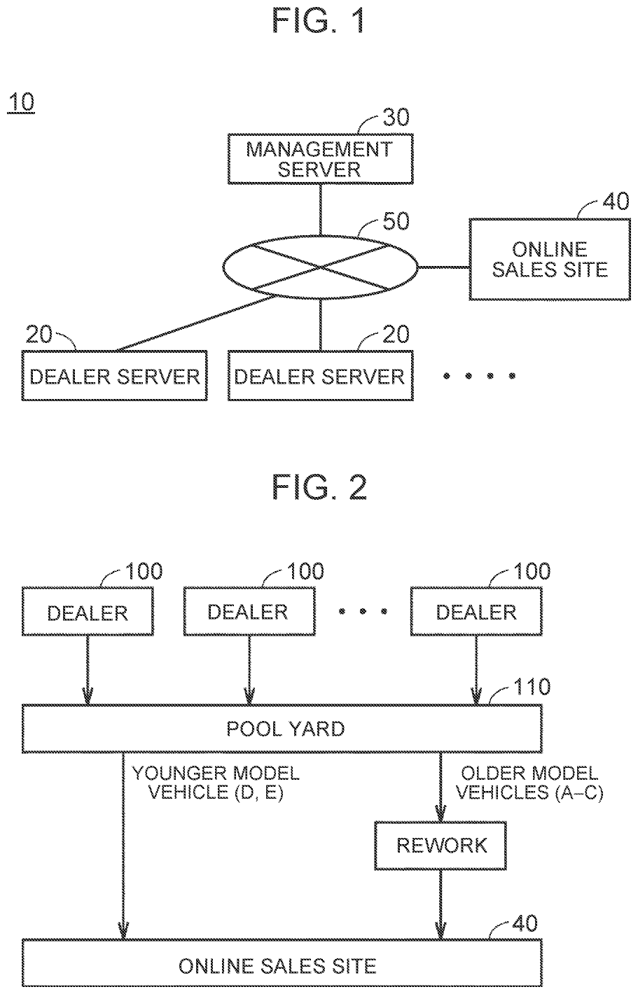

FIG. 1 schematically shows the overall configuration of a used car selling system according to a first embodiment. Referring to FIG. 1, a used car selling system 10 includes a plurality of dealer servers 20, a management server 30, and an online sales site 40. The dealer servers 20, the management server 30, and the online sales site 40 are configured to be communicable with each other via a communication network 50 such as the Internet.

The dealer servers 20 are computers installed at used car dealers. The dealer servers 20 have various information (vehicle names, model types, model years, etc.) on used cars owned by their corresponding dealers. In the first embodiment, the used cars owned by the corresponding dealers are divided into vehicles directly sold at each of the dealers and vehicles sold on the online sales site 40 instead of at the dealers. On the online sales site 40, used cars owned by a plurality of dealers in an appropriately segmented region are pooled and collectively sold. The used car selling system 10 deals with used cars for sale on the online sales site 40. Hereinafter, the used cars for sale on the online sales site 40 may be referred to as “target used cars.” Each of the dealer servers 20 transmits information on the target used cars for sale on the online sales site 40 to the management server 30 through the communication network 50.

The management server 30 is a computer that collects and manages the target used cars owned by the dealers to sell them on the online sales site 40. The management server 30 communicates with the dealer servers 20 and the online sales site 40 through the communication network 50 to exchange various information with the dealer servers 20 and the online sales site 40.

In the first embodiment, the management server 30 acquires information on the target used cars from each of the dealer servers 20 through the communication network 50. The management server 30 then sorts the target used cars into used cars that are put on sale after prescribed rework (function addition) is performed, and used cars that are put on sale without rework (without function addition). The management server 30 arranges rework for the target used cars to be reworked.

More specifically, the means for promoting used cars sales may include enhancing the appeal of used cars as a product. In order to enhance the appeal of the used cars, the used car selling system 10 according to the first embodiment fits a travel safety system relating to vehicle travel safety performance (i.e., applies rework) on the used cars that satisfy a prescribed condition (described later), and sells them on the online sales site 40. The demands for mounting the travel safety system are growing in recent years. Selling the used cars fitted with the travel safety system greatly enhances the appeal of the used cars as a product.

In the used car selling system according to the first embodiment, it is possible to sell the target used cars on the online sales site 40 by additionally fitting such travel safety systems as a pedal misapplication acceleration control system, a pre-crash safety (PCS), and a cruise control. The pedal misapplication acceleration control system is configured to reduce acceleration of the vehicle caused by pedal misapplication between an accelerator pedal and a brake pedal. The PCS is a system that automatically applies the brakes when there is a risk of collision. The cruise control is a system that allows travel at a preset constant speed, without the need to press the accelerator pedal at the time of traveling on highways, for example.

The travel safety systems fittable at the time of used car sales are not limited to these systems. Other travel safety systems may also be fittable. In the first embodiment, the above three systems are described as typical travel safety systems fittable at the time of used car sales. In the following description, the “travel safety system” refers to at least one of the pedal misapplication acceleration control system, the pre-crash safety (hereinafter referred to as “PCS”), and the cruise control.

The management server 30 determines whether or not the target used cars included in the information received from the dealer servers 20 are vehicles fittable with the travel safety system. The management server 30 further sorts out vehicles to be reworked from the vehicles fittable with the driving safety system. Specifically, the management server 30 sorts out, from the target used cars fittable with the travel safety system, the vehicles to be fitted with the travel safety system according to a prescribed parameter (prescribed condition).

The parameter may be, for example, a model type (vehicle model) or a model year (younger model). Alternatively, the parameter may be a combination of the model type and the model year (younger vehicles with prescribed model types). When vehicles are graded according to the model type, the model year, or the like, the parameter may be such a grade. The parameter may further include a sales region of the target used cars. In some sales regions, for example, used cars are mainly purchased by export dealers. In such regions, low-cost used cars are popular. Hence, the used cars for sales in such regions may be excluded from rework targets.

The management server 30 then executes processing to make an arrangement with a vehicle manufacturer to provide the travel safety system fittable on the target used cars that are sorted out as the rework targets. Specifically, the management server 30 executes processing to order parts relating to the target travel safety system to the manufacturer, and also executes processing to arrange fitting operators, operation date and time, operation location, and the like.

The management server 30 also transmits information on the target used cars (including information on presence or absence of rework) to the online sales site 40 through the communication network 50, and posts the information on the target used cars on the online sales site 40. The management server 30 also executes processing (settlement processing or the like) to sell the target used cars to which a purchase request is made on the online sales site 40.

FIG. 2 shows an example of a flow until the target used cars are posted on the online sales site 40. Referring to FIG. 2, the used cars owned by the dealers 100 are sorted into vehicles to be sold directly at the dealers 100 and vehicles to be sold on the online sales site 40. The vehicles to be sold on the online sales site 40 are brought together in a prescribed pool yard 110. The pool yard 110 is shared by two or more dealers 100 in each region of an appropriate range. The information about the target used cars brought together in the pool yard 110 is transmitted from the dealer servers 20 of the dealers 100 to the management server 30 (FIG. 1).

The target used cars brought together in the pool yard 110 are sorted into the vehicles to be reworked, i.e., the vehicles to be additionally fitted with the travel safety system, and the vehicles without rework, according to the parameter (condition). For the used cars to be reworked, arrangement and equipping of the necessary travel safety system are collectively performed, and then the used cars are posted on the online sales site 40. Thus, the target used cars are collectively managed, and the travel safety system is arranged and equipped accordingly. This makes it possible to enhance the efficiency of an operation of selling the used cars with the travel safety system fitted thereto. On the other hand, the used cars without rework are posted on the online sales site 40 as they are.

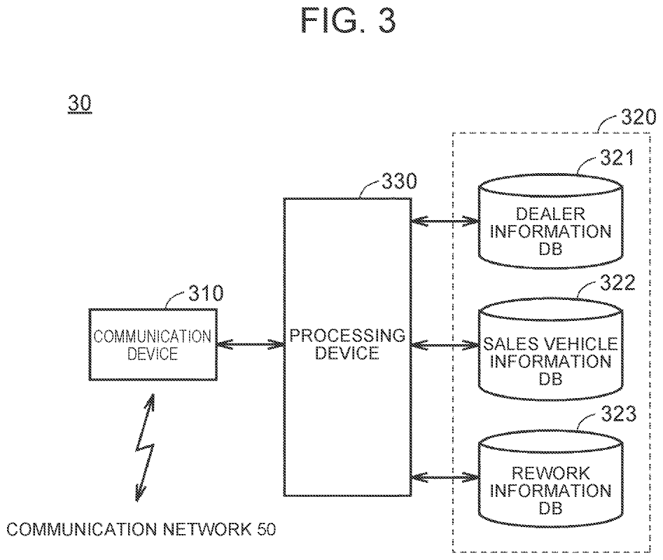

FIG. 3 shows the configuration of the management server 30 shown in FIG. 1. With reference to FIG. 3, the management server 30 includes a communication device 310, a storage device 320, and a processing device 330. The communication device 310 is configured to be bidirectionally communicable with the dealer servers 20 and the online sales site 40 via the communication network 50.

The storage device 320 includes a dealer information database (DB) 321, sales vehicle information DB 322, and a rework information DB 323. The dealer information DB 321 stores information on the dealers 100. For example, the dealer information DB 321 stores various information such as the identification number, location, and contact information of each of the dealers 100, and the location or identification number, or the like, of the pool yard 110.

The sales vehicle information DB 322 stores information on target used cars to be posted on the online sales site 40. In other words, the sales vehicle information DB 322 stores information on the target used cars acquired from the dealer servers 20. A data configuration of the sales vehicle information DB 322 will be described later.

The rework information DB 323 stores information about reworkable vehicles, i.e., vehicles additionally fittable with the travel safety system. Specifically, the rework information DB 323 stores information about vehicles fittable with each of the systems: the pedal misapplication acceleration control system, the PCS, and the cruise control. A data configuration of the rework information DB 323 will also be described later.

The processing device 330 includes a central processing unit (CPU) 21, memories (a read-only memory (ROM) and a random-access memory (RAM)), and an input-output buffer, which are not illustrated. The CPU expands and executes programs stored in the ROM in the RAM. The programs stored in the ROM describe various processing executed by the processing device 330.

The processing device 330 acquires information on the target used cars to be posted on the online sales site 40 through the communication device 310, and registers the acquired information on the target used cars in the sales vehicle information DB 322. The processing device 330 then determines whether or not each of the target used cars registered in the sales vehicle information DB 322 is a vehicle to be reworked. Specifically, the processing device 330 determines with reference to the rework information DB 323 whether or not each of the target used cars registered in the sales vehicle information DB 322 is fittable with each of the travel safety systems (pedal misapplication acceleration control system, PCS, and cruise control).

When any fittable travel safety system is present for each of the target used cars, the processing device 330 executes processing to arrange the travel safety system. For example, in the case of fitting the pedal misapplication acceleration control system, the processing device 330 executes processing to order parts of the system (such as bumpers equipped with an ultrasonic sensor, wiring from the ultrasonic sensor to an in-vehicle electronic control unit (ECU), and ECU software) to manufacturers. The processing device 330 further executes processing to order a fitting operation to a prescribed process management server (not illustrated) that manages operators to perform fitting operations, operation date and time, operation locations, and the like. Once the parts are fitted to the target used cars, the processing device 330 updates the rework information on the target used cars in the sales vehicle information DB 322, and also transmits the information on the target used cars to the online sales site 40 through the communication network 50.

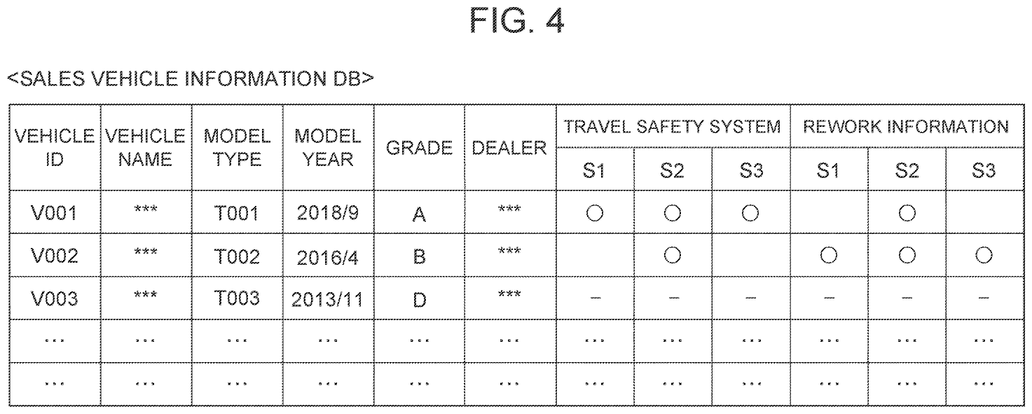

FIG. 4 shows a configuration example of data stored in the sales vehicle information DB 322 in the management server 30. With reference to FIG. 4, the vehicle ID is an identification number used to identify a used car sold on the online sales site 40. Various data, including a vehicle name, a model type, a model year, a grade, a dealer, presence or absence of travel safety systems, and rework information, of the used car, is associated with the vehicle ID.

The model year indicates the year and month of manufacture or the year and month of registration of the vehicle. The grade is basically determined according to the model year, and expressed by A to E, for example. Vehicles closer to grade A have younger model year (newer vehicles). Vehicles closer to grade E have older model year (older vehicles). The grade may be determined in consideration of travel distance, equipment, and the like, in addition to the model year.

The column of the travel safety system indicates the status of each of the travel safety systems equipped on the corresponding used car. Specifically, travel safety systems S1 to S3 indicate the pedal misapplication acceleration control system, the PCS, and the cruise control, respectively. A circle indicates that the corresponding travel safety system is already equipped.

The column of the rework information indicates the presence or absence of rework applied to the corresponding used car. Specifically, the rework information Si indicates that the corresponding used car is put on sale on the online sales site 40 after fitting (rework) of the pedal misapplication acceleration control is performed. The rework information S2 indicates that PCS rework is performed when the corresponding used car is put on sale on the online sales site 40. In the first embodiment, the PCS rework indicates that ECU software of the PCS is reprogrammed (upgraded). The rework information S3 indicates that the corresponding used car is put on sale on the online sales site 40 after equipping (rework) of the cruise control is performed. The rework information may be written when the corresponding system is arranged, or when the rework is actually performed.

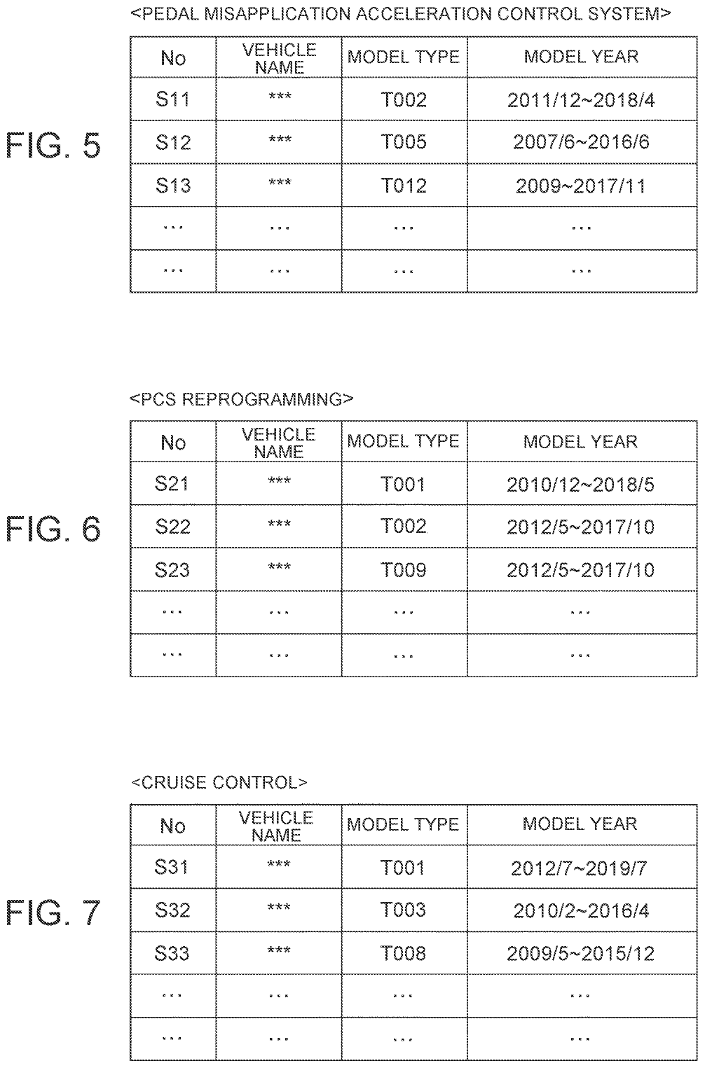

FIGS. 5 to 7 show configuration examples of data stored in the rework information DB 323 in the management server 30. The rework information DB 323 stores information about vehicles fittable with each of the systems, i.e., the pedal misapplication acceleration control system, the PCS, and the cruise control.

FIG. 5 shows information on vehicles fittable with the pedal misapplication acceleration control system. As shown in FIG. 5, the vehicle names, model types, and model years of the vehicles fittable with the pedal misapplication acceleration control system are stored as a list. As shown in the drawing, the vehicle models of the vehicles fittable with the pedal misapplication acceleration control system are predetermined. Moreover, the model years of the vehicle having the same predetermined vehicle models fittable with the pedal misapplication acceleration control system are also predetermined. The processing device 330 of the management server 30 determines based on the information stored in the rework information DB 323 whether or not each of the target used cars registered in the sales vehicle information DB 322 (FIG. 4) is fittable with the pedal misapplication acceleration control system.

FIG. 6 shows information on vehicles that allows PCS reprogramming. As shown in FIG. 6, the vehicle names, model types, and model years of the vehicles that allow reprogramming of the ECU software of the PCS are stored as a list. As shown in the drawing, the vehicle models of the vehicles that allow reprogramming of the ECU software of the PCS are predetermined. Moreover, the model years of the vehicles having the same predetermined vehicle models that allow the reprogramming are also predetermined. The processing device 330 of the management server 30 determines based on the information stored in the rework information DB 323 whether or not each of the target used cars registered in the sales vehicle information DB 322 allows reprogramming of the ECU software of the PCS.

FIG. 7 shows information on vehicles equippable with the cruise control. As shown in FIG. 7, the vehicle names, model types, and model years of the vehicles equippable with the cruise control are stored as a list. As shown in the drawing, the vehicle models of the vehicles equippable with the cruise control are predetermined. Moreover, the model years of the vehicles having the same predetermined vehicle models equippable with the cruise control are also predetermined. The processing device 330 of the management server 30 determines based on the information stored in the rework information DB 323 whether or not each of the target used cars registered in the sales vehicle information DB 322 is equippable with the cruise control.

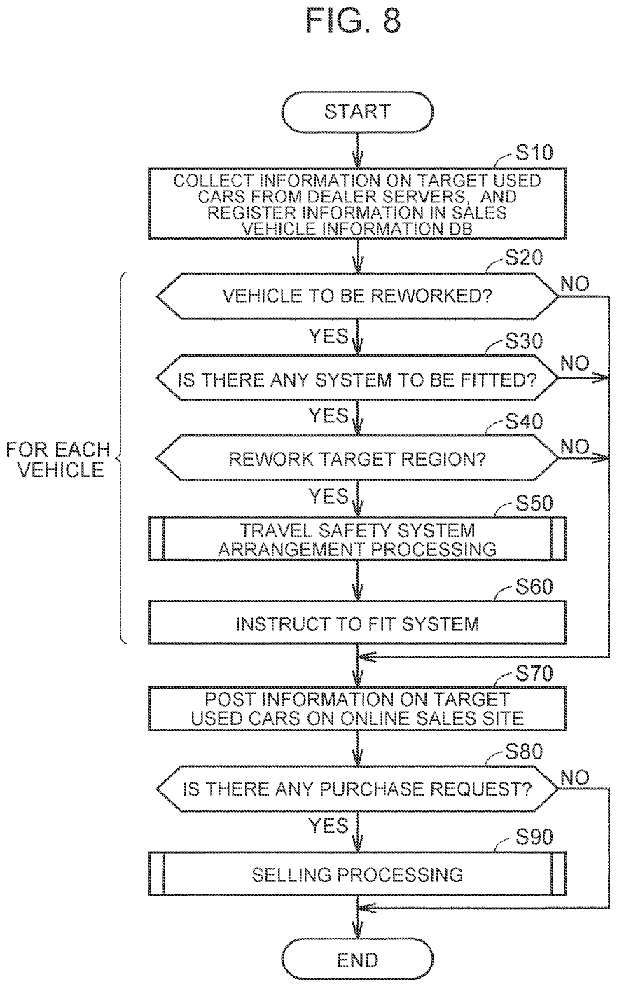

FIG. 8 is a flowchart showing an example flow of processing executed in the management server 30. Referring to FIGS. 1 to 3 as well as FIG. 8, the management server 30 collects information on the target used cars to be sold on the online sales site 40 from each of the dealer servers 20, and registers the collected information on the target used cars in the sales vehicle information DB 322 in the storage device 320 (step S10).

The management server 30 then determines whether or not each of the used cars registered in the sales vehicle information DB 322 is a vehicle to be reworked for the travel safety system rework (Step S20). Specifically, the management server 30 first refers to the rework information DB 323 of the storage device 320 to determine whether or not each of the target used cars registered in the sales vehicle information DB 322 is fittable with travel safety systems. More specifically, the management server 30 determines whether each of the target used cars is fittable with the pedal misapplication acceleration control system, allows reprogramming of the PCS software, and is equippable with the cruise control. Then, the management server 30 determines with reference to the sales vehicle information DB 322 of the storage device 320 whether or not to set the target used cars fittable with the travel safety systems as a rework target.

Whether or not to set the target used cars as a rework target may be determined according to the model type (vehicle model) of the target used cars, determined according to the model year, determined according to a combination of the model type and the model year, or determined according to the grade. For example, the management server 30 may set vehicles of younger models with grades A to C as the vehicles to be reworked, and may exclude vehicles of older models with grades D, E from the vehicles to be reworked even when the vehicles are reworkable.

Each piece of processing from step S20 to step S40 described later is executed for each vehicle registered in the sales vehicle information DB 322. When it is determined in step S20 that the target used car is not the vehicle to be reworked (No in step S20), the processing shifts to step S70 (described later).

When it is determined in step S20 that the target used car is the vehicle to be reworked for the travel safety system (YES in step S20), the management server 30 checks whether there is any travel safety system fittable to the target used car (step S30). In other words, the management server 30 checks the status of equipping any travel safety system on the target used car with reference to the sales vehicle information DB 322 of the storage device 320, and determines whether there is any travel safety system that is not yet equipped but fittable to the pertinent target used car. When it is determined in step S30 that there is no travel safety system to be fitted on the target used car (NO in step S30), the processing shifts to step S70 (described later).

When there is a travel safety system to fit on the target used car in step S30 (YES in step S30), the management server 30 determines whether or not the sales region of the target used car is a rework target region (step S40). As described above, depending on sales regions, low-price used cars without rework may be popular. Hence, the processing makes it possible to exclude such regions from the rework target. When it is determined in step S40 that the sales region of the target used car is not the rework target region (NO in step S40), the processing shifts to step S70 described later. Note that step S40 is not essential processing. When, there is no need to distinguish the rework target region from other regions, the processing of step S40 may be omitted.

Next, the management server 30 executes processing to arrange the travel safety system to be equipped on the target used car (Step S50). The processing of step S50 is executed in a certain lot-unit (as a group) for the target used cars belonging to the sales region that is determined to be the rework target region in step S40. For example, the lot may be a period of time (e.g., one week), or may be the number of travel safety systems to be arranged (the number of vehicles to be reworked). The processing executed in step S50 will be described later in detail.

Once the arrangement of the travel safety system is completed, the management server 30 instructs to fit (equip) the arranged travel safety system on the target used cars (step S60). The processing of step S60 is also executed in a certain lot-unit (as a group) for the vehicles for which the travel safety system is arranged in step S50.

When fitting the travel safety system on the vehicles to be reworked is completed, or when NO is determined in any one of steps S20 to S40, the management server 30 transmits the information on the target used cars and an instruction to post on the online sales site 40 to the online sales site 40 through the communication network 50. As a result, the information on the target used cars are posted on the online sales site 40 (step S70).

When there is a purchase request for any one of the posted used cars on the online sales site 40 (YES in step S80), the management server 30 executes selling processing (settlement, etc.) to sell the used car to which the purchase request is made, based on prescribed procedures not illustrated (step S90).

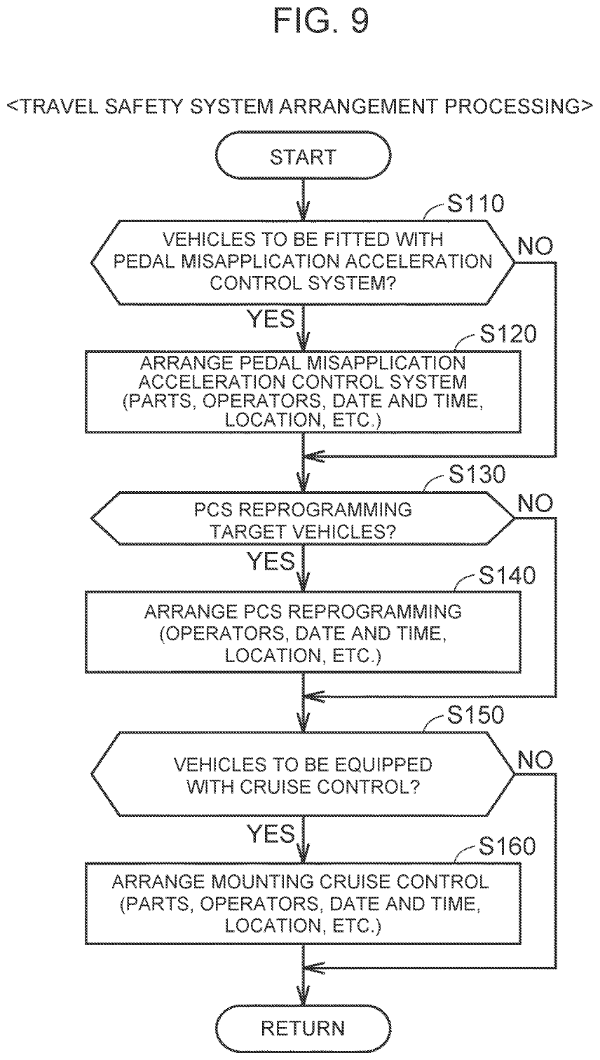

FIG. 9 is a flowchart for illustrating an example of travel safety system arrangement processing executed in step S50 in FIG. 8. With reference to FIG. 9, the management server 30 determines whether or not the used cars to be reworked are vehicles to be fitted with the pedal misapplication acceleration control system (Step S110). Specifically, the management server 30 refers to the sales vehicle information DB 323 of the storage device 320 to determine the target used cars not equipped with the pedal misapplication acceleration control system as the vehicles to be fitted with the system.

When it is determined in step S110 that the target used cars are vehicles to be fitted with the pedal misapplication acceleration control system (YES in step S110), the management server 30 arranges the pedal misapplication acceleration control system to be fitted on the target used cars (step S120). Specifically, the management server 30 executes processing to order parts relating to the pedal misapplication acceleration control system (such as bumpers equipped with an ultrasonic sensor, wiring from the ultrasonic sensor to an in-vehicle ECU, and ECU software) to manufacturers. The management server 30 also executes processing to order a fitting operation to the process management server that manages operators, operation date and time, operation locations, and the like.

Next, the management server 30 determines whether or not the used cars to be reworked are PCS reprogramming target vehicles (Step S130). Specifically, the management server 30 refers to the sales vehicle information DB 323 of the storage device 320 to determine the target used cars without a PCS reprogramming history as PCS reprogramming target vehicles.

When it is determined in step S130 that the target used cars are PCS reprogramming target vehicles (YES in step S130), the management server 30 arranges the PCS reprogramming for the target used cars (step S140). Specifically, the management server 30 executes processing to order PCS programming software to a manufacturer, and also executes processing to order a PCS reprogramming operation to the process management server that manages operators, operation date and time, operation locations, and the like.

The management server 30 further determines whether or not the used cars to be reworked are vehicles to be equipped with the cruise control (Step S150). Specifically, the management server 30 refers to the sales vehicle information DB 323 of the storage device 320 to determine the target used cars not equipped with the cruise control as the vehicles to be equipped with the cruise control.

When it is determined in step S150 that the target used cars are vehicles to be equipped with the cruise control (YES in step S150), the management server 30 arranges to equip the cruise control on the target used cars (step S160). Specifically, the management server 30 executes processing to order parts relating to the cruise control (such as bumpers equipped with a sensor, wiring from the sensor to an in-vehicle ECU, and ECU software) to manufacturers. The management server 30 also executes processing to order a fitting operation to the process management server that manages operators, operation date and time, operation locations, and the like.

As described in the foregoing, in the first embodiment, it is possible to sell used cars fitted with the travel safety system or systems at the time of used car sales. The demands for equipping such a travel safety system are growing more and more in recent years. Selling the used cars fitted with the travel safety system can greatly contribute to enhancing the appeal of the used cars as a product at the time of used car sales. Therefore, according to the first embodiment, it is possible to enhance the appeal of used cars as a product.

### Second Embodiment

In the first embodiment, the management server 30 determines whether or not to fit the travel safety system or systems (whether or not to perform rework) on each of the used cars brought from the dealers 100 according to the model type, the model year, or the like of the vehicles. In a second embodiment, prospective buyers can optionally select the presence or absence of rework of the reworkable used cars on the online sales site 40.

The overall configuration of a used car selling system according to the second embodiment is similar to the used car selling system according to the first embodiment shown in FIGS. 1 to 3.

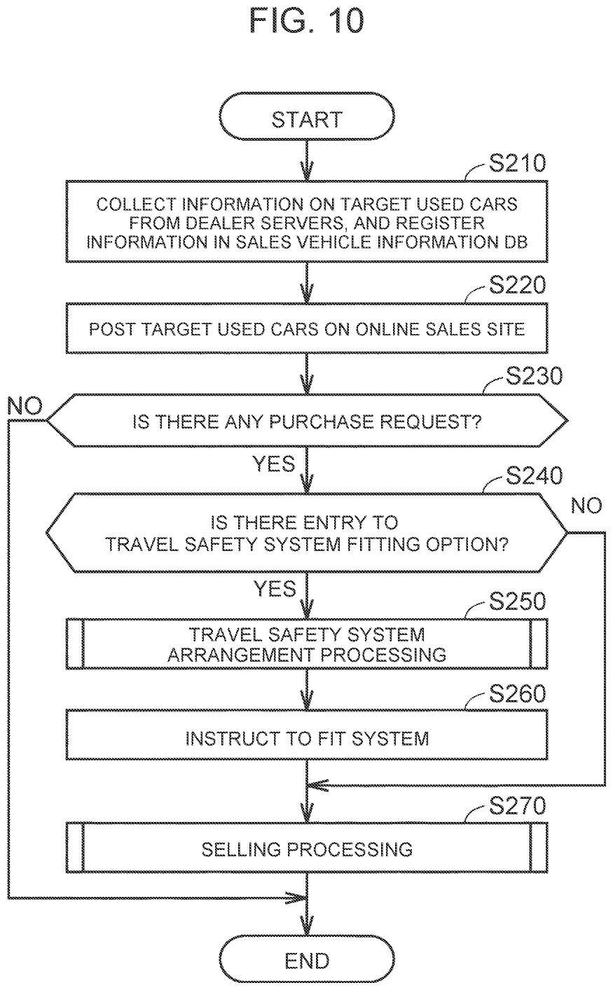

FIG. 10 is a flowchart showing an example flow of processing executed in the management server 30 in the second embodiment. Referring to FIGS. 1 to 3 as well as FIG. 10, the management server 30 collects information on the target used cars to be sold on the online sales site 40 from each of the dealer servers 20, and registers the collected information on the target used cars in the sales vehicle information DB 322 in the storage device 320 (step S210).

In the second embodiment, the management server 30 transmits the information on the used cars registered in the sales vehicle information DB 322 and an instruction to post the information on the online sales site 40 to the online sales site 40 through the communication network 50. Consequently, the information on the target used cars are posted on the online sales site 40 (step S220).

In the second embodiment, the management server 30 determines with reference to the rework information DB 323 of the storage device 320 whether or not the target used cars are fittable with each of the travel safety systems (pedal misapplication acceleration control system, PCS, and cruise control). When the travel safety systems are fittable, the information thereon is also transmitted to the online sales site 40. The fact that the travel safety systems are fittable is posted, together with the target used cars, on the online sales site 40 as an option offered at the time of purchasing the target used cars.

When there is a request to purchase a used car on the online sales site 40 (YES in step S230), the management server 30 checks whether or not there is an entry to an option for fitting any travel safety system for the used car to which the purchase request is made on the online sales site 40 (step S240). When there is no entry to the option (NO in step S240), the processing shifts to step S270 described later.

When it is determined in step S240 that there is an entry to the option for fitting any travel safety system (YES in step S240), the management server 30 executes processing to arrange the travel safety system that is selected as an option (step S250). The processing executed in step S250 will be described later in detail. Once the arrangement of the travel safety system is completed, the management server 30 instructs to fit (equip) the arranged travel safety system on the target used car (step S260).

When fitting the travel safety system in response to the entry to the option is completed, or when NO is determined in step S240, the management server 30 executes selling processing (settlement, etc.) to sell the used car to which the purchase request is made based on prescribed procedures not illustrated (step S270).

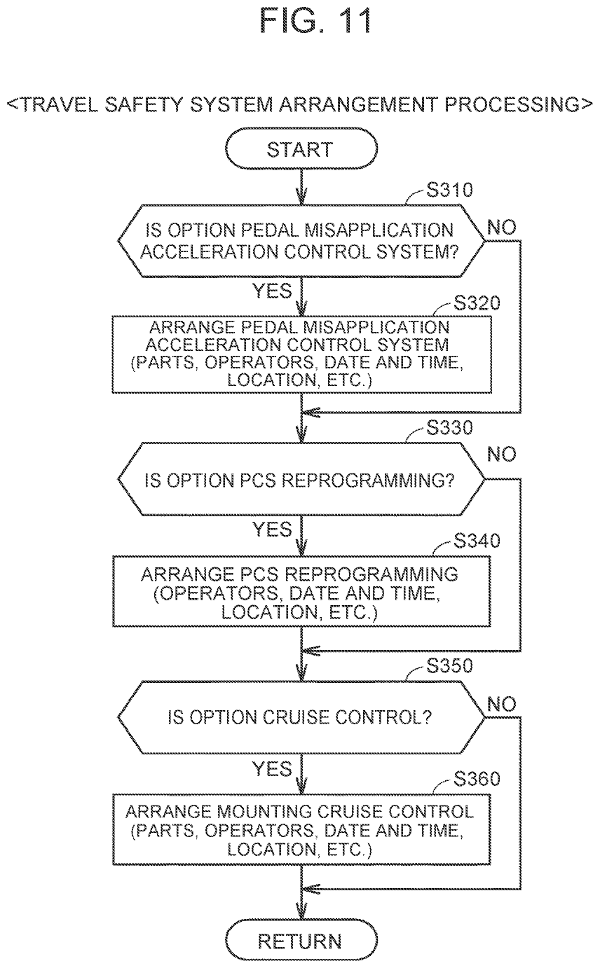

FIG. 11 is a flowchart for illustrating an example of travel safety system arrangement processing executed in step S250 in FIG. 10. As it is disclosed on FIG. 11, when there is an entry to the option for the pedal misapplication acceleration control system at the time of making a purchase request on the online sales site 40 (YES in step S310), the management server 30 arranges the pedal misapplication acceleration control system to be fitted on the target used car (step S320). The processing is similar to step S120 shown in FIG. 9.

When where is an entry to the option for the PCS reprogramming at the time of making a purchase request on the online sales site 40 (YES in step S330), the management server 30 arranges the PCS reprogramming for the target used car (step S340). The processing is also similar to step S140 shown in FIG. 9.

When there is an entry to the option for mounting the cruise control at the time of making a purchase request on the online sales site 40 (YES in step S350), the management server 30 arranges to mount the cruise control on the target used car (step S360). The processing is similar to step S160 shown in FIG. 9.

As described in the foregoing, in the second embodiment, the travel safety system can be arranged and fitted on the used car for sale in response to a request from the prospective buyer of the used car on the online sales site 40. This makes it possible to enhance the appeal of the used car as a produced to reflect the user's request.

It should be understood that the embodiments disclosed herein are in all respects illustrative and are not considered as the basis for restrictive interpretation. The technical scope disclosed by the present disclosure is not defined by the foregoing description of the embodiments. Rather, it is defined by the range of appended claims. All changes which come within the range of the claims and meaning and the range of equivalency thereof are therefore intended to be embraced therein.

What is claimed is:

1. A used car selling system for use in used car sales, comprising:
a storage device configured to store information on vehicles that are retrofittable with a travel safety system relating to travel safety performance of the vehicles; and
a controller configured to acquire information on target used cars as sales targets and determine, based on the information stored in the storage device, whether or not the target used cars are vehicles fittable with the travel safety system, wherein
the controller is configured to
execute first processing to arrange the travel safety system for the target used cars fittable with the travel safety system, and
execute second processing to sell the target used cars fitted with the travel safety system.

2. The used car selling system according to claim 1, wherein the travel safety system includes a pedal misapplication acceleration control system configured to reduce acceleration of the vehicles caused by pedal misapplication between an accelerator pedal and a brake pedal.

3. The used car selling system according to claim 1, wherein the first processing includes
processing to sort out, from the target used cars fittable with the travel safety system, target used cars to be fitted with the travel safety system in accordance with a prescribed parameter, and
processing to arrange the travel safety system for the sorted target used cars.

4. The used car selling system according to claim 3, wherein the first processing further includes processing to determine the travel safety system fittable for each of the target used cars in accordance with the parameter.

5. The used car selling system according to claim 3, wherein the parameter includes at least one of a model type, a model year, and a sales region of the vehicles.

6. The used car selling system according to claim 1, wherein:
the controller is configured to receive fitting of the travel safety system from a prospective buyer of the target used car;
the first processing includes processing to arrange the travel safety system, received from the prospective buyer, for the target used car fittable with the travel safety system; and
the second processing includes selling the target used car fitted with the travel safety system arranged by the first processing to the prospective buyer.

7. A used car selling method for use in used car sales, comprising:
a step of acquiring first information including information on target used cars as sales targets;
a step of acquiring second information including information on vehicles retrofittable with a travel safety system relating to travel safety performance of the vehicles;
a step of determining based on the second information whether or not the target used cars are vehicles fittable with the travel safety system;
a step of arranging the travel safety system for the target used cars that are determined to be fittable with the travel safety system; and
a step of selling the target used cars fitted with the travel safety system.
